(19) United States
(12) Patent Application Publication
(10) Pub. No.: US 2020/0341746 A1
(43) Pub. Date: Oct. 29, 2020

(54) SNAPSHOT RECOVERY STATES

(71) Applicant: MICROSOFT TECHNOLOGY LICENSING, LLC, Redmond, WA (US)

(72) Inventors: Karan MEHRA, Sammamish, WA (US); Emanuel PALEOLOGU, Kirkland, WA (US)

(21) Appl. No.: 16/398,197

(22) Filed: Apr. 29, 2019

(51) Int. Cl. G06F 8/65; G06F 9/4401

(52) U.S. Cl. CPC G06F 8/65; G06F 9/441

(57) ABSTRACT

Data is stored that defines a known good state for a current operating system that can launch the computing device to the known good state in response to a reboot of a computing device. The data is associated with an indication that the data is usable to reboot the computing device. The operating system is updated to generate an updated state that can launch the computing device to the updated state in response to a reboot. The updated state is associated with an indication that the data is usable to reboot the computing device for a limited number of attempts. In response to a failed reboot, the reboot is retried until the known good state is to be used for reboot. When the known good state is to be used for reboot, the known good state is reverted to and the computing device is rebooted using the known good state.

### BACKGROUND

In computing systems, operating systems, applications, and other software are frequently updated to provide improved features, fix bugs, and improve the security of a computing device by protecting against new malware threats. Software updates may be installed by running update programs from media such as a CD-ROM. Updates can also be downloaded via the Internet. Many applications include an automatic update feature that checks for updated versions and download/install the updates, typically with user permissions.

Operating systems may also have an update feature that will download and install new versions and patches to the operating system. In a typical update, various files and data may be downloaded, and the process may involve additional files and data being downloaded as the update process continues. Once the update is completed and the updates are installed, the updated software may be loaded for execution, and the files and data that were used for the update may be deleted.

It is with respect to these and other considerations that the disclosure made herein is presented.

### SUMMARY

Systems and methods are described that enable a computing device to maintain and update a known good operating system state, while improving the operation and efficiency of the mechanisms for doing so. The known good state may refer generally to an operating system state that is configured to boot the computing device and support normal operational scenarios in a predictable and repeatable manner. The computing device can maintain data that defines and/or is usable to reenter the known good operating system state when the device is rebooted.

When an operating system is updated, various portions of the operating system are typically updated. The system may be rebooted and the updated operating system may be loaded. When the reboot with the updated operating system fails, it is important to return the system to a known clean state. However, it may be difficult to return cleanly to such a state, as some portion of the updates may remain in the reverted operating system. In many cases, it may not be possible to remove all updates that were added to the operating system, thereby making it impossible to completely to achieve a clean separation between the previous and new operating system.

One solution is to retain and store a full copy of the existing operating system and load a full and separate version of the new operating system. However, maintaining two full versions of an operating system may take a significant amount of storage space. The space usage may be exacerbated when rollbacks are desired, requiring multiple versions of the operating system to be retained. It is desirable therefore to be able to achieve a clean separation between current and new versions of the operating system while minimizing the required storage space, and at the same time allowing for a clean recovery in the event of a failed boot or if other issues occur during the updated, such as a power loss during the boot.

In various embodiments, techniques for creating and maintaining separate and clean versions of operating system updates while allowing for rollback is disclosed. In an embodiment, updates to various operating system sets or groupings may be stored as snapshots. For example, the sets may include a main operating system space, which may include the OS binaries, as well as data, applications, user data, and driver sets.

In an embodiment, a snapshot may be taken of all the sets. In one embodiment, the snapshots may be taken when system setup is started or at other opportunistic times for those sets that are read-only, since these sets will not be changed during the course of operation of the computing system. The operating system update may then begin. Changes to the other sets may be tracked. In sets that are changed during operation of the computing device, such as the data space, the snapshot may be taken at the last possible point before rebooting the computing system. The snapshots for different sets may be taken at different times, based on requirements for each set. The snapshots may be taken opportunistically, based on a predetermined schedule, or based on system conditions and other triggers.

In an embodiment, only the differences between the updated operating system and the current operating system may be tracked in order to reduce required storage space as well as to limit the scope of changes so that the operating system can be reverted in the event of a failure of the updated operating system. In some embodiments, the differences may be tracked using virtual disks or virtual storage volumes. In one embodiment, the sets that make up the current operating system version may be saved as one or more virtual disks. The virtual disk is a representation of the underlying data that is physically stored, so other than metadata that define the virtual disk and its mappings, a separate physical copy of the current operating system version need not be separately created. Updates to the operating system can be tracked in the newly created virtual disks, which are tracked as deltas to the version that was stored (snapshotted) in the original version.

Once the snapshots are taken and the changes are tracked, the computing system may be rebooted with the updated operating system. In an embodiment, the number of attempts that the computing device may attempt to reboot with the updated operating system may be limited by a predetermined value or indicator. For example, the updated operating system may be limited to a single reboot attempt, or finite number of reboot attempts. A boot limiting mechanism may be implemented that limits the reboot attempts, and once the allowed number of reboot attempts have been attempted and have filed, the boot limiting mechanism may allow for the current operating system to be loaded and used for the next reboot. In one embodiment, the updated but failed operating system may be discarded.

In an embodiment, the boot limiting mechanism may include a reboot count for each operating system version that is defined on a computing device. The updated operating system version may be assigned a reboot count of one or other finite value. The current operating system may be assigned a value that indicates that there is no limit to the number of times that it can be used for boot, or that the current operating system may be used when there are no other versions that are associated with a finite reboot count. For example, the current operating system may be assigned a value of infinity or an arbitrary high number. Each time that a given operating system is booted and experiences a failure, the reboot count may be decremented so that when a reboot count of zero is reach, the boot limiting mechanism prevents that operating system version from being loaded for further boot attempts.

If an updated operating system version is successfully used for boot, then the current operation system version that has been snapshotted can be discarded, or can be saved in the event that reversion is desired at a future point in time. After some specified period of time, or after one or more events such as the operating system version being considered obsolete, then that version may be discarded.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### DRAWINGS

The Detailed Description is described with reference to the accompanying figures. In the description detailed herein, references are made to the accompanying drawings that form a part hereof, and that show, by way of illustration, specific embodiments or examples. The drawings herein are not drawn to scale. Like numerals represent like elements throughout the several figures.

FIG. 1 is an example functional diagram in accordance with the present disclosure;

FIG. 2 is an example computing device in accordance with the present disclosure;

FIG. 3 is a diagram illustrating snapshots in accordance with the present disclosure;

FIG. 4 is a diagram illustrating snapshots in accordance with the present disclosure;

FIG. 5 is a diagram illustrating snapshots in accordance with the present disclosure;

FIG. 6 is a flowchart depicting an example procedure for implementing techniques in accordance with the present disclosure.

FIG. 7 is a flowchart depicting an example procedure for implementing techniques in accordance with the present disclosure.

FIG. 8 is an example computing device in accordance with the present disclosure;

### DETAILED DESCRIPTION

The following Detailed Description describes systems and methods that enable a computing device to maintain and update a known good operating system state, while improving the operation and efficiency of the mechanisms for doing so. The known good state may refer generally to an operating system state that is configured to boot the computing device and support normal operational scenarios. The computing device can maintain data that defines and/or is usable to reenter the known good operating system state when the device is rebooted.

When an operating system is updated, various portions of the operating system are typically updated. The system may be rebooted and the updated operating system may be loaded. When the reboot with the updated operating system fails, it is important to return the system to a known clean state. However, it may be difficult to return to such a state, as some portion of the updates may remain in the reverted operating system. In many cases, it may not be possible to cleanly remove all updates that were added to the operating system, thereby making it impossible to completely to achieve a clean separation between the previous and new operating system.

One solution is to retain and store a full copy of the existing operating system and load a full and separate version of the new operating system. However, maintaining two full versions of an operating system may take a significant amount of storage space. The space usage may be exacerbated when rollbacks are desired, requiring multiple versions of the operating system to be retained. It is desirable therefore to be able to achieve a clean separation between current and new versions of the operating system while minimizing the required storage space, and at the same time allowing for a clean recovery in the event of a failed boot or if other issues occur during the updated, such as a power loss during the boot.

In various embodiments, techniques for creating and maintaining separate and clean versions of operating system updates is disclosed. In an embodiment, updates to various operating system sets or groupings may be stored. For example, the sets may include a main operating system space, which may include the OS binaries, as well as data, applications, user data, and driver sets.

In an embodiment, a snapshot may be taken of all the sets. In one embodiment, the snapshots may be taken when system setup is started or at other opportunistic times for those sets that are read-only, since these sets will not be changed during the course of operation of the computing system. The operating system update may then begin. Changes to the other sets may be tracked. In sets that are changed during operation of the computing device, such as the data space, the snapshot may be taken at the last possible point before rebooting the computing system. In an embodiment, only the differences between the updated operating system and the current operating system may be tracked in order to reduce required storage space as well as to limit the scope of changes so that the operating system can be reverted in the event of a failure of the updated operating system.

In some embodiments, the differences may be tracked using virtual disks or virtual storage volumes. In one embodiment, the sets that make up the current operating system version may be saved as one or more virtual disks. The virtual disk is a representation of the underlying data that is physically stored, so other than metadata that define the virtual disk and its mappings, a separate physical copy of the current operating system version need not be separately created and stored. Updates to the operating system can be tracked in the newly created virtual disks, which are tracked as deltas to the version that was stored in the original version.

Once the snapshots are taken and the changes are tracked, the computing system may be rebooted with the updated operating system. In an embodiment, the number of attempts that the computing device may attempt to reboot with the updated operating system may be limited by a predetermined value. For example, the updated operating system may be limited to a single reboot attempt, or finite number of reboot attempts. A boot limiting mechanism may be implemented that limits the reboot attempts, and once the allowed number of reboot attempts have been attempted and have filed, the boot limiting mechanism may allow for the current operating system to be loaded and used for the next reboot. In one embodiment, the updated but failed operating system may be discarded.

In an embodiment, the boot limiting mechanism may include a reboot count for each operating system version that is defined on a computing device. The updated operating system version may be assigned a reboot count of one or other finite value. The current operating system may be assigned a value that indicates that there is no limit to the number of times that it can be used for boot, or that the current operating system may be used for boot when there are no other operating system versions that have a finite boot count. For example, the current operating system may be assigned a value of infinity or an arbitrary high number. Each time that a given operating system is booted and experiences a failure, the reboot count may be decremented so that when a reboot count of zero is reached, the boot limiting mechanism prevents that operating system version from being loaded for further boot attempts.

In an embodiment, metadata may be stored that describes the sets for each operating system version. Each set may be tagged with an operating system version. For example, the main OS may be tagged as Main OS1 for set 1, and Main OS2 for set 2. Only one set may be active at any given time, thus preventing multiple operating system versions to appear to be valid.

If an updated operating system version is successfully used for boot, then the current operation system version that has been snapshotted can be discarded, or can be saved in the event that reversion is desired at a future point in time. After some specified period of time, or after one or more events such as the operating system version being considered obsolete, then that version may be discarded.

In an embodiment, a mechanism for updating operating systems using snapshots can include:

1. a collection of spaces or sets that function together to collectively form the new operating system version;

2. an active set that is a current and known operating system version; this set is given a reboot count of infinity that allows for continuous (infinite) attempts to boot, as long as there are no other versions that have a finite boot count;

3. an override set that is an updated operating system version; this set is given a finite boot count that allows for limited attempts to boot. When the limited number of attempts have been made without success, the boot priority returns to the active set (e.g., the set that has an infinite boot count).

By separating the active and override sets and using a boot count that limits the number of times that an override set (updated operating system version) can be allowed to boot, the system can avoid repeated boot attempts that fail, while also allowing for the ability to cleanly separate operating system versions. Only one operating system set is active at one time, and only one override set is allowed to attempt boots, with limits. This also avoids problems today where new and old operating system versions may exist in the same space.

In an embodiment, the code for managing sets and limiting the boot attempts with count limits may reside in a boot manager that is decoupled from the operating system.

In some embodiments, when an updated operating system version fails to properly boot, the user may be presented with a message or other notification indicating what caused the update to fail. In one embodiment, the message or notification may have a link to a website or other source that provides more detail regarding causes for the failure and next steps. The failure may also be associated with an identifier that may be provided to a support site. The user may also be provided an option to make further attempts in case the error is transient.

In some embodiments, telemetry data may be sent to a service or support provider to determine how often rollbacks are occurring and whether there is a particular failure signature that is more frequent. Otherwise, if the system fails to boot and the associated information is not sent via telemetry, the information may not be available for analysis. With a successful rollback, not only is the user returned to functional operation, but the service provider may be provided information to better understand how often the update is failing and why. In some embodiments, a temporary virtual disk may be created to store progress and logs for the update. The temporary virtual disk may be separate from any operating system sets and isolated from the operating system. When a rollback occurs, the contents of the temporary virtual disk may be accessed to determine what failed and where.

The described techniques may be used in the context of a client device such as a PC, laptop, or mobile device. The operating system update may be pushed down to the client device and automatically launched. The user may be notified about the update and asked to begin or defer the update. The described techniques may also be used in the context of server-based systems and virtualized environments. For example, a data center administrator may want to update multiple servers and/or computing instances, and it would be useful to allow for the updates to be implemented using rollback control and snapshotting as described herein.

One objective in the described scenarios is to prevent a system from entering an unusable state. By applying an update on top of an existing working version, the system may become destabilized. The described techniques can prevent such situations that may lead to instability. Furthermore, the described techniques may be implemented using a variety of operating systems. By using cleanly separated operating system versions via sets and snapshots and mutually exclusive version and reboot control to avoid bricking as described, a system may preserve a working version of the operating system in a stable state. Furthermore, the use of telemetry to collect data for failure analysis may provide further benefits to support and service providers.

Among many other benefits, the techniques described herein improve efficiencies with respect to configuring computing devices to repeatedly attempt to install operating system updates or even to lose the ability to boot the computing device into a known operational state. Furthermore, the techniques described enable a clean operating system state to be persisted, and in some embodiments, for multiple states to be snapshotted and persisted. Thus, the described techniques improve computing efficiencies and/or human interaction with computers at least due to mitigating the burden of failed operating system updates. The described techniques also allow for a clean operating system state to be maintained while improving the efficient utilization of storage and processing to efficiently enable updates in a controlled and predictable manner.

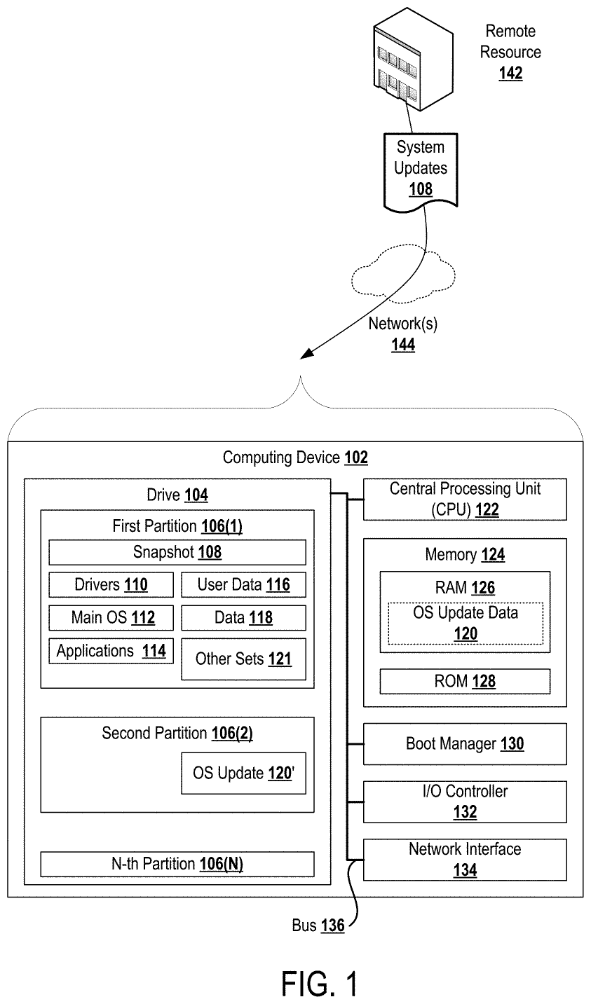

Turning to FIG. 1, illustrated is an example computing system 100 for maintaining operating system state data 120 to maintain an ability to repeatedly attempt operating system boots and/or revert to a known state. The computing device 102 provides an ability to modify and persist the operating system state by updating the operating system state data 120.

Example system components include, but are not limited to, drivers 110, an operating system (OS) 112, an application 114, a registry 116, and/or libraries 118. The example computing system 100 enables the computing device 102 to execute any aspects of the software components and/or functionality presented herein. Furthermore, the example computing architecture 100 illustrated in FIG. 1 shows an example architecture for a personal computer (e.g., a laptop and/or desktop computer), a tablet computer, a smart phone, a server computer, a server rack, a network of server computers, or any other types of computing devices suitable for implementing the functionality described herein.

As illustrated in FIG. 1, the computing device 102 may include one or more drive(s) 104 (hereinafter referred to as the “drive”) having computer-readable media that provides nonvolatile storage for the computing device 102. Example drives include, but are not limited to, SATA-type solid-state hard drives, SATA-type hard disks, PATA-type solid-state hard drives, PATA-type hard disks, and/or any other drive-type suitable for providing non-volatile computer-readable media to a computing device. The drive 104 may include multiple partitions 106 for logically separating one or more system components and/or data objects.

In the illustrated example, the drive 104 is separated into a first partition 106(1), a second partition 106(2), and an N-th partition 106(N). In some embodiments, at least one of the partitions 106 stores drivers 110, main operating system (OS) 112, application set 114, user data set 116, and data set 118. Boot manager 130 may be configured to initiate the drivers 110 and to load the OS 112 and other sets into a memory 124. In the illustrated example, the memory 124 includes a random-access memory (“RAM”) 126 and a read-only memory (“ROM”) 128. As further illustrated, the computing device 102 includes a central processing unit (“CPU”) 122 that is connected, via a bus 136, to the drive 104, the memory 124, and the boot manager 130. In some embodiments, the bus 136 further connects an input/output (I/O) controller 132 and/or a network interface 134.

It can be appreciated that the system components described herein (e.g., the drivers 110, the OS 112, and/or the application set 114) may, when loaded into the CPU 122 and executed, transform the CPU 122 and the overall computing device 102 from a general-purpose computing system into a special-purpose computing system customized to facilitate the functionality presented herein. The CPU 122 may be constructed from any number of transistors or other discrete circuit elements, which may individually or collectively assume any number of states. More specifically, the CPU 122 may operate as a finite-state machine, in response to executable instructions contained within the software modules disclosed herein. These computer-executable instructions may transform the CPU 122 by specifying how the CPU 122 transitions between states, thereby transforming the transistors or other discrete hardware elements constituting the CPU 122.

The drive 104 and associated computer-readable media provide non-volatile storage for the computing device 102. Although the description of computer-readable media contained herein refers to a mass storage device, such as a solid-state drive and/or a hard disk, it should be appreciated by those skilled in the art that computer-readable media can be any available non-transitory computer storage media or communication media that can be accessed by a computing architecture such as, for example, the computing architecture 100. Communication media includes computer-readable instructions, data structures, and/or program modules. By way of example, and not limitation, communication media includes wired media such as a wired network or direct-wired connection. Combinations of the any of the above are also included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer storage media includes, but is not limited to, RAM, ROM, EPROM, EEPROM, flash memory or other solid-state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computing device 102. For purposes of the claims, the phrase “computer storage medium,” “computer-readable storage medium,” and variations thereof, does not include waves, signals, and/or other transitory and/or intangible communication media, per se.

The boot manager 130 may access the main OS 112 from the drive 104 (or a partition thereof) and may load the main OS 112 into the memory 124 for runtime execution by the computing device 102 (e.g., by invoking an OS boot loader). During execution of an OS booting protocol, the boot manager 130 (and/or an OS boot loader thereof) may identify the presence of (and/or verify a validity of) the operation system update data 120. The boot manager 130 may load the operation system update data 120 into the memory 124 to access data for an updated operating system state.

The I/O controller 132 may receive and process input from a number of other devices, including a keyboard, mouse, or electronic stylus (not shown in FIG. 1). Similarly, the I/O controller 132 may provide output to a display screen, a printer, or other type of output device (also not shown in FIG. 1). The network interface 134 may enable the computing device 102 to connect to one or more network(s) 144 such as a local area network (LAN), a wide area network (WAN), a wireless local area network (WLAN), or any other suitable network for passing information between the computing device 102 and a remote resource 142.

As described above, the drive 104 may include multiple partitions 106 for logically separating one or more system components and/or data objects. In the illustrated example, the drive 104 includes the first partition 106(1) which stores instances of the drivers 110, the main OS 112, the application set 114, the user data set 116, the data set 118, and the operating system update data 120. The drivers 110 may include one or more programs for controlling one or more devices that are communicatively coupled to the computing device 102 such as, for example, printers, displays, cameras, soundcards, network cards, computer storage devices, etc. The main OS 112 may be any suitable system software for managing computer hardware and/or software resources and for providing services to the application set 114 and/or other applications (not shown). An example main OS 112 may include, but is not limited to, various versions of MICROSOFT WINDOWS (e.g., WINDOWS 8.1 or 10, WINDOWS EMBEDDED STANDARD 7, etc.), Mac OS X, iOS, etc.

The application set 114 may be a computer program that is configured to be run by the main OS 112 to perform one or more coordinated functions, tasks, and/or activities. Example applications 114 include, but are not limited to, applications configured to support one or more specific operations and/or general applications (e.g., a word processor and/or spreadsheet application, a web browser application, etc.).

The main OS 112 may include a database containing information usable to boot and/or configure the main OS 112, system-wide software settings that control the operation of the OS 112, security databases, and/or user specific configuration settings. The main OS 112 may further contain information associated with in-memory volatile data such as, for example, a current hardware state of the main OS 112 (e.g., which drivers are currently loaded and in use by the OS 112).

The main OS 112 may include libraries which may be a collection of non-volatile resources that are usable (e.g., callable) by the application set 114 and/or other applications (not shown). Example resources include, but are not limited to, pre-written code and/or subroutines, configuration data, and/or classes (e.g., extensible program-code-templates for creating objects of various types). In various implementations, the libraries may enable the application 114 to call upon various system services provided by the main OS 112. For example, the libraries may include one or more subsystem Dynamic Link Libraries (DLLs) configured for implementing and/or exposing Application Programming Interface (API) functionalities of the main OS 112 to the application set 114.

The operation system update data 120 may define an operating system state of the computing device 102 and/or system components thereof. From a known good state of the operating system, the operation system update data 120 may be loaded into the memory 124 to attempt a boot of the updated operating system.

It can be appreciated, therefore, that the operation system update data 120 may correspond to a snapshot 108 of the current operating system of the computing device 102 and may include data about the drivers 110, the main OS 112, and other sets that are operational at the time the current operating system state is snapshotted (recorded).

For example, upon receipt of an instruction to save data defining the current operating system state, the computing device 102 (and/or a power manager thereof) may access and compress contents of the memory 124 that pertain to the current operating system and save the compressed contents of the memory 124 to snapshot data 108.

The operation system update data 120 is stored on the drive 104, which provides non-volatile storage for the computing device 102. The computing device 102 may be fully powered down (or even abruptly lose power) without losing access to the operation system update data 120. When the computing device 102 is later turned on it may automatically transition to the current operating system state because the boot manager 130 may identify that the current operating system state has a count of infinity and no other operating system version has a count great than zero. However, if the updated operating system 120′ stored in the second partition 106(2) has a count greater than zero, then the operation system update data 120′ has priority for the current boot, and the boot manager 130 may execute a specific booting protocol to cause the computing device 102 to load and execute the updated operating system 120′.

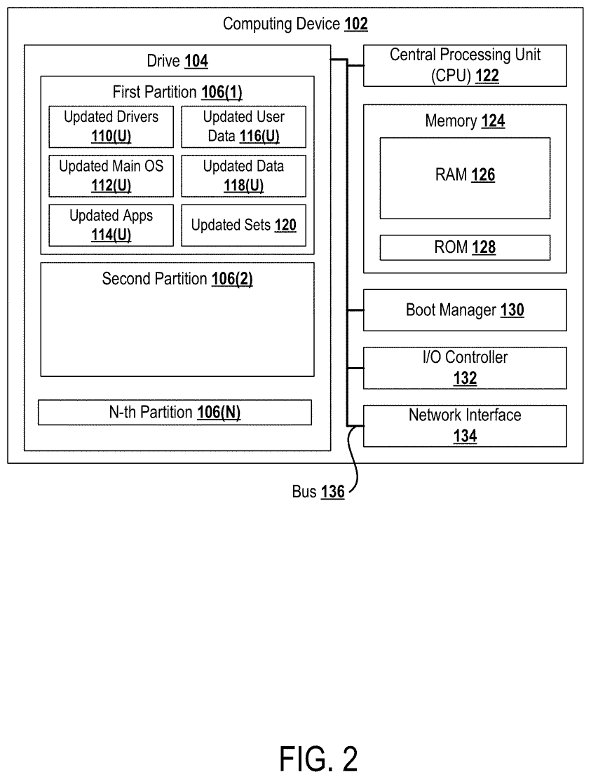

Turning to FIG. 2, the example computing system 100 is illustrated following the incorporation of an updated operating system resulting in at least some of the system components being updated based on the successful boot of the updated operating system. In the illustrated example, aspects of several system components have been updated and, therefore, the first partition 106(1) is shown to include updated drivers 110(U), an updated main OS 112(U), updated application set 114(U), updated user data set 116(U), and updated data set 118(U).

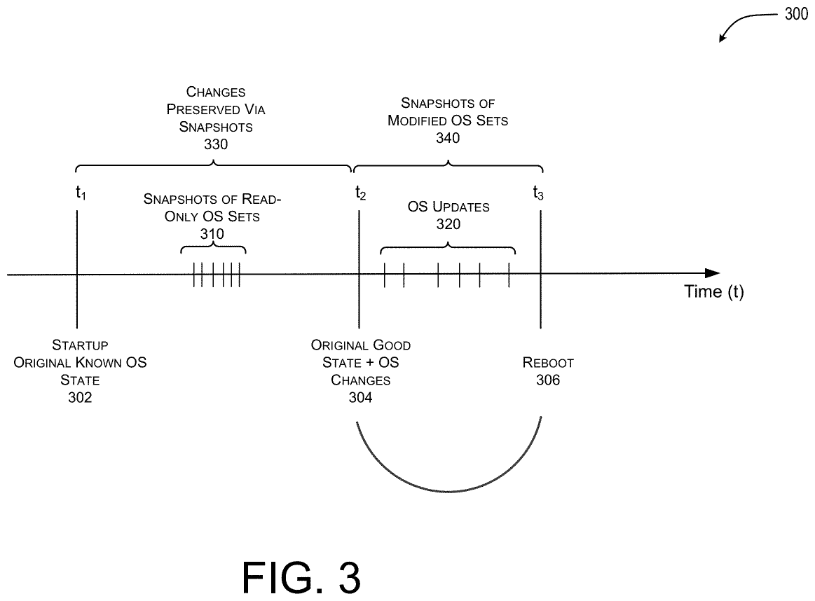

Turning to FIG. 3, illustrated is an example implementation of snapshots in accordance with the present disclosure. FIG. 3 depicts a timing diagram 300 illustrating start-up 302 of a device at time t1, where the device is initially booted using the known operating system state. Until time t2 when the updated operating system is received, snapshots of the current operating system set may be captured. The changes are depicted as snapshot sets 310.

After time t2, operating system updates 320 are added to the current operating system in preparation for reboot 306. The snapshots 310 are persisted and can be made available for future reboots if needed.

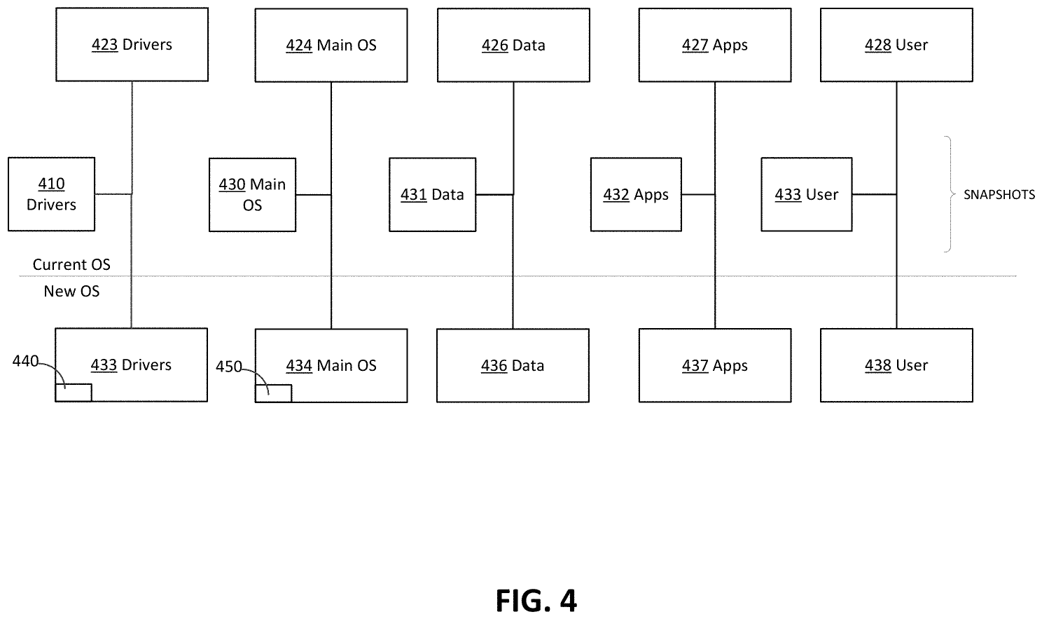

Referring to FIG. 4, illustrated is an example implementation of snapshots in accordance with the present disclosure. FIG. 4 depicts an operating system set comprising drivers 423, main OS 424, data 426, applications 427, and user set 428. When an operating system update is to be attempted, snapshots of the drivers 410, main OS 430, data 431, applications 432, and user set 433 may be taken of the operating system set comprising drivers 423, main OS 424, data 426, applications 427, and user set 428. After the snapshots are taken, the operating system updates may be loaded included drivers 433, main OS 434, data 436, applications 437, and user set 438. In some embodiments only the deltas may be saved such as changes 440 to drivers 433 and changes 450 to main OS 434. In some embodiments, the snapshots may be implemented as one or more virtual disks that represent the snapshotted version. For example, one snapshot may be captured to preserve the state of one or more sets, and another snapshot may be captured that can be modified to incorporate the operating system updates. The sets show in FIG. 4 are examples, and other sets may be defined for a given operating system.

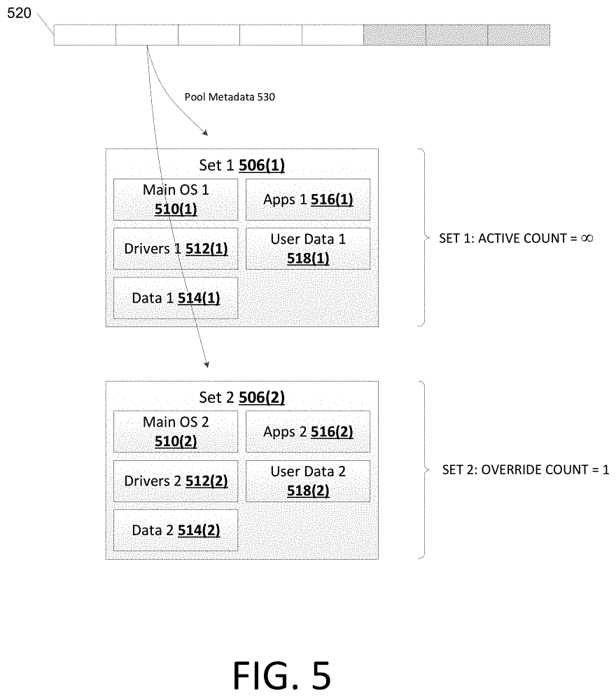

Referring to FIG. 5, illustrated is an example implementation of snapshots in accordance with the present disclosure. FIG. 5 depicts a storage volume 520 that includes metadata 530 for a storage pool for the operating system versions. The metadata 530 may describe a first set 506(1) that may define a current operating system comprising drivers set 1 512(1), main OS set 1 510(1), data set 1 514(1), applications set 1 516(1), and user data set 1 518(1). Operating system set 1 506(1) may be associated with an active count of infinity to indicate that there is no limit to the number of reboots that may be performed with this operating system version.

Metadata 530 may further describe a second set 506(2) that may define an updated operating system comprising drivers set 2 512(2), main OS set 2 510(2), data set 2 514(2), applications set 2 516(2), and user data set 2 518(2). Operating system set 2 506(2) may be associated with an override count of one to indicate that the number of reboots that may be performed with this operating system version is limited to one.

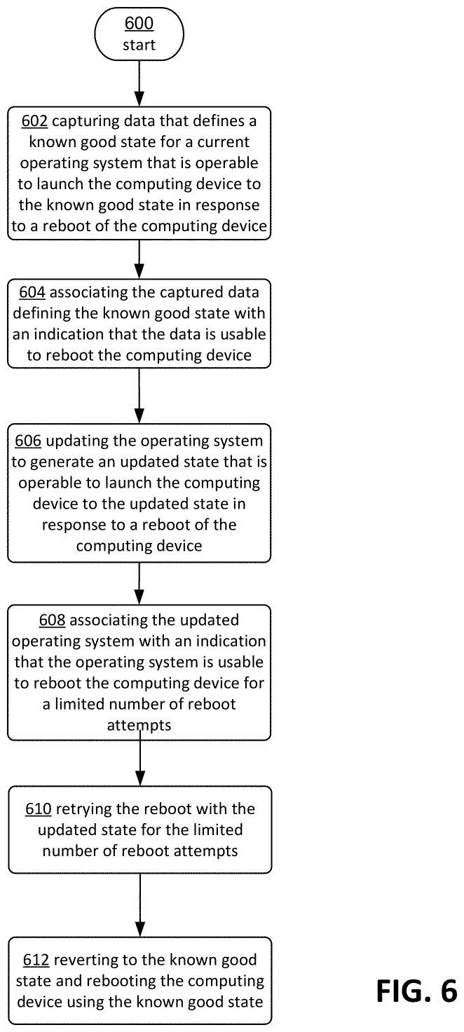

Referring to FIG. 6, illustrated is an example operational procedure in accordance with the present disclosure. Referring to FIG. 6, Operation 600 begins the procedure, and operation 602 illustrates capturing data that defines a known good state for a current operating system that is operable to launch the computing device to the known good state in response to a reboot of the computing device. In an embodiment, the captured data includes read-only sets that are not updated during operation of the computing device, and modifiable sets that can be updated during operation of the computing device. Additionally, and optionally, the read-only sets are captured on an opportunistic basis and the modifiable sets are captured when the computing device is to be rebooted.

Operation 602 may be followed by Operation 604. Operation 604 illustrates associating the captured data defining the known good state with an indication that the data is usable to reboot the computing device when there are no other usable operating system versions. Operation 604 may be followed by Operation 606. Operation 606 illustrates updating the operating system to generate an updated state that is operable to launch the computing device to the updated state in response to a reboot of the computing device. In an embodiment, updates to the operating system are isolated from the captured data. Operation 606 may be followed by Operation 608. Operation 608 illustrates associating the updated operating system with an indication that the operating system is usable to reboot the computing device for a limited number of reboot attempts. In an embodiment, the updated operating system has reboot priority over the captured data when the limited number is non-zero. Operation 608 may be followed by Operation 610. Operation 610 illustrates in response to a failed reboot of the computing device with the updated state, retrying the reboot with the updated state for the limited number of reboot attempts.

When the computing device has been rebooted for a limited number of reboot attempts without a successful reboot, operation 610 may be followed by operation 612. Operation 612 illustrates reverting to the known good state and rebooting the computing device using the known good state.

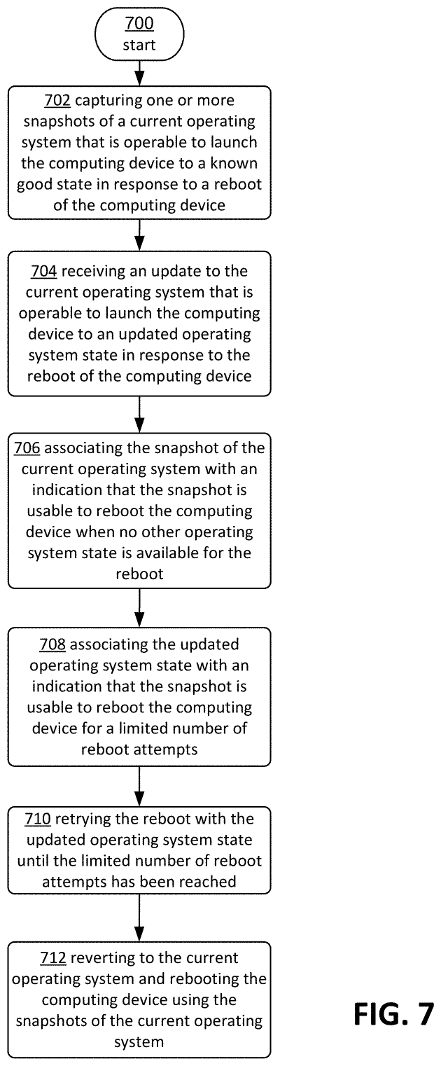

Referring to FIG. 7, illustrated is an example operational procedure in accordance with the present disclosure. Referring to FIG. 7, Operation 700 begins the procedure, and operation 702 illustrates capturing one or more snapshots of a current operating system that is operable to launch the computing device to a known good state in response to a reboot of the computing device.

Operation 702 may be followed by Operation 704. Operation 704 illustrates receiving an update to the current operating system that is operable to launch the computing device to an updated operating system state in response to the reboot of the computing device. Operation 704 may be followed by Operation 706. Operation 706 illustrates associating the snapshot of the current operating system with an indication that the snapshot is usable to reboot the computing device when no other operating system state is available for the reboot. Operation 706 may be followed by Operation 708. Operation 708 illustrates associating the updated operating system state with an indication that the snapshot is usable to reboot the computing device for a limited number of reboot attempts. Operation 708 may be followed by Operation 710. Operation 710 illustrates in response to a failed reboot with the updated operating system state, retrying the reboot with the updated operating system state until the limited number of reboot attempts has been reached.

When the limited number of reboot attempts has been reached, operation 710 may be followed by operation 712. Operation 712 illustrates reverting to the current operating system and rebooting the computing device using the snapshots of the current operating system.

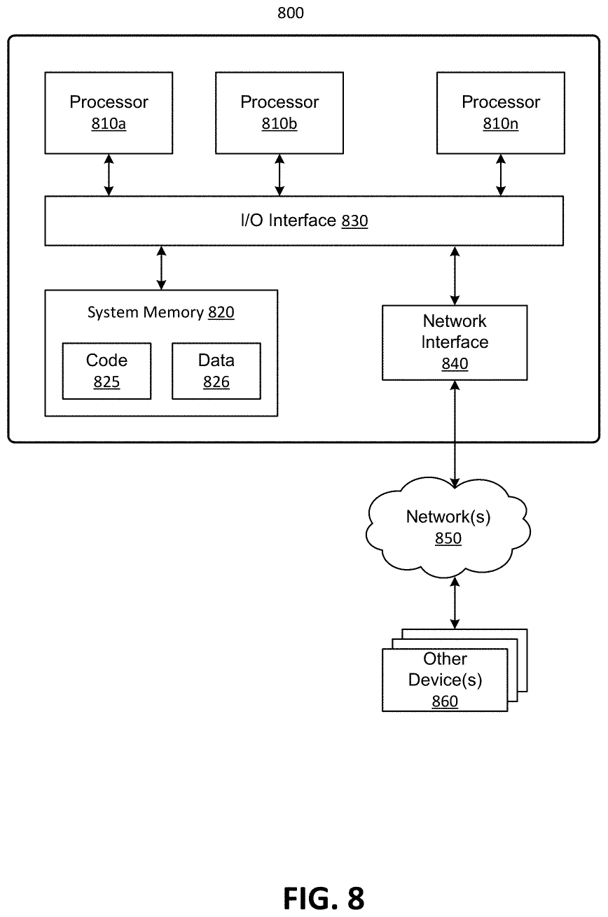

In at least some embodiments, a computing device that implements a portion or all of one or more of the technologies described herein, including the techniques to implement the functionality of a device may include a general-purpose computer system that includes or is configured to access one or more computer-accessible media. FIG. 8 illustrates such a general-purpose computing device 800. In the illustrated embodiment, computing device 800 includes one or more processors 810a, 810b, and/or 810n (which may be referred herein singularly as “a processor 810” or in the plural as “the processors 810”) coupled to a system memory 820 via an input/output (I/O) interface 830. Computing device 800 further includes a network interface 840 coupled to I/O interface 830.

In various embodiments, computing device 800 may be a uniprocessor system including one processor 810 or a multiprocessor system including several processors 810 (e.g., two, four, eight, or another suitable number). Processors 810 may be any suitable processors capable of executing instructions. For example, in various embodiments, processors 810 may be general-purpose or embedded processors implementing any of a variety of instruction set architectures (ISAs), such as the x86, PowerPC, SPARC, or MIPS ISAs, or any other suitable ISA. In multiprocessor systems, each of processors 810 may commonly, but not necessarily, implement the same ISA.

System memory 820 may be configured to store instructions and data accessible by processor(s) 810. In various embodiments, system memory 820 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing one or more desired functions, such as those methods, techniques and data described above, are shown stored within system memory 820 as code 825 and data 826.

In one embodiment, I/O interface 830 may be configured to coordinate I/O traffic between processor 810, system memory 820, and any peripheral devices in the device, including network interface 840 or other peripheral interfaces. In some embodiments, I/O interface 830 may perform any necessary protocol, timing, or other data transformations to convert data signals from one component (e.g., system memory 820) into a format suitable for use by another component (e.g., processor 810). In some embodiments, I/O interface 830 may include support for devices attached through various types of peripheral buses, such as a variant of the Peripheral Component Interconnect (PCI) bus standard or the Universal Serial Bus (USB) standard, for example. In some embodiments, the function of I/O interface 830 may be split into two or more separate components, such as a north bridge and a south bridge, for example. Also, in some embodiments some or all of the functionality of I/O interface 830, such as an interface to system memory 820, may be incorporated directly into processor 810.

Network interface 840 may be configured to allow data to be exchanged between computing device 800 and other device or devices 860 attached to a network or network(s) 850, such as other computer systems or devices as illustrated in FIGS. 1 through 11, for example. In various embodiments, network interface 840 may support communication via any suitable wired or wireless general data networks, such as types of Ethernet networks, for example. Additionally, network interface 840 may support communication via telecommunications/telephony networks such as analog voice networks or digital fiber communications networks, via storage area networks such as Fibre Channel SANs or via any other suitable type of network and/or protocol.

In some embodiments, system memory 820 may be one embodiment of a computer-accessible medium configured to store program instructions and data as described above for FIGS. 1-6 for implementing embodiments of the corresponding methods and apparatus. However, in other embodiments, program instructions and/or data may be received, sent or stored upon different types of computer-accessible media. Generally speaking, a computer-accessible medium may include non-transitory storage media or memory media, such as magnetic or optical media, e.g., disk or DVD/CD coupled to computing device 800 via I/O interface 830. A non-transitory computer-accessible storage medium may also include any volatile or non-volatile media, such as RAM (e.g. SDRAM, DDR SDRAM, RDRAM, SRAM, etc.), ROM, etc., that may be included in some embodiments of computing device 800 as system memory 820 or another type of memory. Further, a computer-accessible medium may include transmission media or signals such as electrical, electromagnetic or digital signals, conveyed via a communication medium such as a network and/or a wireless link, such as may be implemented via network interface 840. Portions or all of multiple computing devices, such as those illustrated in FIG. 8, may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computing device,” as used herein, refers to at least all these types of devices and is not limited to these types of devices. For purposes of this specification and the claims, the phrase “computer-readable storage medium” and variations thereof, does not include waves, signals, and/or other transitory and/or intangible communication media.

Each of the processes, methods and algorithms described in the preceding sections may be embodied in, and fully or partially automated by, code modules executed by one or more computers or computer processors. The code modules may be stored on any type of non-transitory computer-readable medium or computer storage device, such as hard drives, solid state memory, optical disc and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and subcombinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel or in some other manner. Blocks or states may be added to or removed from the disclosed example embodiments. The example systems and components described herein may be configured differently than described. For example, elements may be added to, removed from or rearranged compared to the disclosed example embodiments.

It will also be appreciated that various items are illustrated as being stored in memory or on storage while being used, and that these items or portions of thereof may be transferred between memory and other storage devices for purposes of memory management and data integrity. Alternatively, in other embodiments some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Accordingly, the present invention may be practiced with other computer system configurations.

Conditional language used herein, such as, among others, “can,” “could,” “might,” “may,” “e.g.” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some or all of the elements in the list.

While certain example embodiments have been described, these embodiments have been presented by way of example only, and are not intended to limit the scope of the inventions disclosed herein. Thus, nothing in the foregoing description is intended to imply that any particular feature, characteristic, step, module or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

### Example Clauses

The disclosure presented herein encompasses the subject matter set forth in the following example clauses.

Example Clause A, a computer-implemented method for updating an operating system of a computing device, the method comprising:

capturing data that defines a known good state for a current operating system that is operable to launch the computing device to the known good state in response to a reboot of the computing device, wherein:
the captured data includes read-only sets that are not updated during operation of the computing device, and modifiable sets that can be updated during operation of the computing device, and
the read-only sets are captured on an opportunistic basis and the modifiable sets are captured when the computing device is to be rebooted;

associating the captured data defining the known good state with an indication that the data is usable to reboot the computing device when there are no other usable operating system versions;

updating the operating system to generate an updated state that is operable to launch the computing device to the updated state in response to a reboot of the computing device, wherein updates to the operating system are isolated from the captured data;

associating the updated operating system with an indication that the operating system is usable to reboot the computing device for a limited number of reboot attempts, wherein the updated operating system has reboot priority over the captured data when the limited number is non-zero;

in response to a failed reboot of the computing device with the updated state, retrying the reboot with the updated state for the limited number of reboot attempts; and

when the computing device has been rebooted for a limited number of reboot attempts without a successful reboot, reverting to the known good state and rebooting the computing device using the known good state.

Example Clause B, the computer-implemented method of Example Clause A, wherein the indication that the data is usable to continuously boot the computing device comprises a boot count of infinity.

Example Clause C, the computer-implemented method of any one of Example Clauses A through B, wherein the indication that the data is usable to reboot the computing device for the limited number of attempts comprises a finite boot count.

Example Clause D, the computer-implemented method of any one of Example Clauses A through C, further comprising decrementing the finite boot count for each attempted boot attempt and retrying the boot with the updated state until the finite boot count reaches zero.

Example Clause E, the computer-implemented method of any one of Example Clauses A through D, wherein reverting to the known good state and booting the computing device using the known good state further comprises presenting options comprising one or more of discarding the updated state, re-attempting the update, providing further information regarding the failed boot, and a summary of the updates.

Example Clause F, the computer-implemented method of any one of Example Clauses A through E, wherein the operating system is implemented as sets of partitions that are separately updatable.

Example Clause G, the computer-implemented method of any one of Example Clauses A through F, wherein the updated sets comprise delta changes to the current operating system that are implemented using virtual storage disks or volumes.

Example Clause H, the computer-implemented method of any one of Example Clauses A through G, further comprising storing multiple operating system updates that each define a known operating system state, wherein only one operating system state has a finite boot count and remaining operating system states have a zero boot count.

While Example Clauses A through H are described above with respect to a computer-implemented method, it is understood in the context of this disclosure that the subject matter of Example Clauses A through H can additionally or alternatively be implemented by a system or device or computer readable medium.

Example Clause I, a computing device comprising:

one or more processors;

a memory in communication with the one or more processors, the memory having computer-readable instructions stored thereupon which, when executed by the one or more processors, cause the computing device to:

capturing one or more snapshots of a current operating system that is operable to launch the computing device to a known good state in response to a reboot of the computing device;

receiving an update to the current operating system that is operable to launch the computing device to an updated operating system state in response to the reboot of the computing device;

associating the snapshot of the current operating system with an indication that the snapshot is usable to reboot the computing device when no other operating system state is available for the reboot;

associating the updated operating system state with an indication that the snapshot is usable to reboot the computing device for a limited number of reboot attempts;

in response to a failed reboot with the updated operating system state, retrying the reboot with the updated operating system state until the limited number of reboot attempts has been reached; and

when the limited number of reboot attempts has been reached, reverting to the current operating system and rebooting the computing device using the snapshots of the current operating system.

Example Clause J, the system of Example Clause I, wherein the indication that the snapshot is usable to continuously reboot the computing device comprises a reboot count of infinity.

Example Clause K, the system of any one of Example Clauses H through J, wherein the limited number of reboot attempts is implemented as a counter that is decremented in response to a failed reboot attempt.

Example Clause L, the system of any one of Example Clauses H through K, wherein the updated operating system state is implemented as delta changes to the snapshot of the current operating system that are implemented using virtual storage disks or volumes.

Example Clause M, the system of any one of Example Clauses H through L, wherein the current operating system and the updated operating system state are implemented as sets of partitions that are separately updatable.

Example Clause N, the system of any one of Example Clauses H through M, wherein when the limited number of reboot attempts has been reached, options are provided that comprise one or more of discarding the updated state, re-attempting the update, providing further information regarding the failed boot, and a summary of the updates.

Example Clause O, the system of any one of Example Clauses H through N, further comprising storing multiple operating system updates that each define a known operating system state.

While Example Clauses H through O are described above with respect to a system, it is understood in the context of this disclosure that the subject matter of Example Clauses H through O can additionally or alternatively be implemented by a device 3 or method or computer readable medium.

Example Clause P, a computer-readable medium having encoded thereon computer-executable instructions that, when executed, cause one or more processing units of a computing device to execute a method comprising:

receiving an update to an operating system that is operable to launch a computing device to an updated operating system state in response to a reboot of the computing device;

capturing one or more snapshots of a current operating system that is operable to launch the computing device to a known good state in response to a reboot of the computing device;

limiting a number of reboot attempts for the updated operating system state; and

enabling the computing device to reboot using the snapshot of the current operating system when the number of reboot attempts for the updated operating system state is reached.

Example Clause Q, the computer-readable medium of any one of Example Clause P, wherein the number of reboot attempts for the updated operating system state is implemented as a counter that is decremented in response to a failed reboot attempt.

Example Clause R, the computer-readable medium of any one of Example Clauses Q through P, wherein the updated operating system state is implemented as delta changes to the snapshot of the current operating system that are implemented using virtual storage disks or volumes.

Example Clause S, the computer-readable medium of any one of Example Clauses Q through R, wherein the current operating system and the updated operating system state are implemented as sets of partitions that are separately updatable.

Example Clause T, the computer-readable medium of any one of Example Clauses Q through S, wherein the method further comprises storing multiple operating system updates that each define a known operating system state.

While Example Clauses Q through T are described above with respect to a computer-readable medium, it is understood in the context of this disclosure that the subject matter of Example Clauses NQ through T can additionally or alternatively be implemented by a method or via a device or via a system.

What is claimed is:

1. A computer-implemented method for updating an operating system of a computing device, the method comprising:
capturing data that defines a known good state for a current operating system that is operable to launch the computing device to the known good state in response to a reboot of the computing device, wherein:
the captured data includes read-only sets that are not updated during operation of the computing device, and modifiable sets that can be updated during operation of the computing device, and
the read-only sets are captured on an opportunistic basis and the modifiable sets are captured when the computing device is to be rebooted;
associating the captured data defining the known good state with an indication that the data is usable to reboot the computing device when there are no other usable operating system versions;
updating the operating system to generate an updated state that is operable to launch the computing device to the updated state in response to a reboot of the computing device, wherein updates to the operating system are isolated from the captured data;
associating the updated operating system with an indication that the operating system is usable to reboot the computing device for a limited number of reboot attempts, wherein the updated operating system has reboot priority over the captured data when the limited number is non-zero;
in response to a failed reboot of the computing device with the updated state, retrying the reboot with the updated state for the limited number of reboot attempts; and
when the computing device has been rebooted for a limited number of reboot attempts without a successful reboot, reverting to the known good state and rebooting the computing device using the known good state.

2. The computer-implemented method of claim 1, wherein the indication that the data is usable to continuously boot the computing device comprises a boot count of infinity.

3. The computer-implemented method of claim 1, wherein the indication that the data is usable to reboot the computing device for the limited number of attempts comprises a finite boot count.

4. The computer-implemented method of claim 3, further comprising decrementing the finite boot count for each attempted boot attempt and retrying the boot with the updated state until the finite boot count reaches zero.

5. The computer-implemented method of claim 1, wherein reverting to the known good state and booting the computing device using the known good state further comprises presenting options comprising one or more of discarding the updated state, re-attempting the update, providing further information regarding the failed boot, and a summary of the updates.

6. The computer-implemented method of claim 1, wherein the operating system is implemented as sets of partitions that are separately updatable.

7. The computer-implemented method of claim 6, wherein the updated sets comprise delta changes to the current operating system that are implemented using virtual storage disks or volumes.

8. The computer-implemented method of claim 1, further comprising storing multiple operating system updates that each define a known operating system state, wherein only one operating system state has a finite boot count and remaining operating system states have a zero boot count.

9. A computing device comprising:
one or more processors;
a memory in communication with the one or more processors, the memory having computer-readable instructions stored thereupon which, when executed by the one or more processors, cause the computing device to:
capturing one or more snapshots of a current operating system that is operable to launch the computing device to a known good state in response to a reboot of the computing device;
receiving an update to the current operating system that is operable to launch the computing device to an updated operating system state in response to the reboot of the computing device;
associating the snapshot of the current operating system with an indication that the snapshot is usable to reboot the computing device when no other operating system state is available for the reboot;
associating the updated operating system state with an indication that the snapshot is usable to reboot the computing device for a limited number of reboot attempts;
in response to a failed reboot with the updated operating system state, retrying the reboot with the updated operating system state until the limited number of reboot attempts has been reached; and
when the limited number of reboot attempts has been reached, reverting to the current operating system and rebooting the computing device using the snapshots of the current operating system.

10. The computing device of claim 9, wherein the indication that the snapshot is usable to continuously reboot the computing device comprises a reboot count of infinity.

11. The computing device of claim 9, wherein the limited number of reboot attempts is implemented as a counter that is decremented in response to a failed reboot attempt.

12. The computing device of claim 9, wherein the updated operating system state is implemented as delta changes to the snapshot of the current operating system that are implemented using virtual storage disks or volumes.

13. The computing device of claim 9, wherein the current operating system and the updated operating system state are implemented as sets of partitions that are separately updatable.

14. The computing device of claim 9, wherein when the limited number of reboot attempts has been reached, options are provided that comprise one or more of discarding the updated state, re-attempting the update, providing further information regarding the failed boot, and a summary of the updates.

15. The computing device of claim 9, further comprising storing multiple operating system updates that each define a known operating system state.

16. A computer-readable medium having encoded thereon computer-executable instructions that, when executed, cause one or more processing units of a computing device to execute a method comprising:
receiving an update to an operating system that is operable to launch a computing device to an updated operating system state in response to a reboot of the computing device;
capturing one or more snapshots of a current operating system that is operable to launch the computing device to a known good state in response to a reboot of the computing device;
limiting a number of reboot attempts for the updated operating system state; and
enabling the computing device to reboot using the snapshot of the current operating system when the number of reboot attempts for the updated operating system state is reached.

17. The computer-readable medium of claim 16, wherein the number of reboot attempts for the updated operating system state is implemented as a counter that is decremented in response to a failed reboot attempt.

18. The computer-readable medium of claim 16, wherein the updated operating system state is implemented as delta changes to the snapshot of the current operating system that are implemented using virtual storage disks or volumes.

19. The computer-readable medium of claim 16, wherein the current operating system and the updated operating system state are implemented as sets of partitions that are separately updatable.

20. The computer-readable medium of claim 16, wherein the method further comprises storing multiple operating system updates that each define a known operating system state.
